(19) United States
(12) Patent Application Publication
(10) Pub. No.: US 2015/0143129 A1
(43) Pub. Date: May 21, 2015

(54) Secure mobile identity

(71) Applicant: Michael Thomas Duffy, Austin, TX (US)

(72) Inventor: Michael Thomas Duffy, Austin, TX (US)

(21) Appl. No.: 13/998,595

(22) Filed: Nov. 15, 2013

(51) Int. Cl. G06F 21/31; G06F 21/41

(52) U.S. Cl. CPC G06F 21/31; G06F 21/41
USPC 713/182

(57) ABSTRACT

A “Secure Mobile Identity System” that enables the creation of secure digital credentials on mobile devices, prevents identity theft, prevents fraudulent financial transactions, protects privacy, enables a simplified federation process and provides a consumer friendly “One Click Sign On”™ process. Also, the user's credentials are secure if his/her mobile device is lost or stolen.

### CROSS-REFERENCE TO RELATED APPLICATIONS

### Application No. 61/796,591

### Filing Date Nov. 15, 2012

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

In the late Seventies and early Eighties computer names were maintained by using handcrafted HOSTS.TXT files. As networks became more interconnected this process became unmanageable. Everyone knew that something needed to be done. When the Domain Name System (DNS) was created everyone saw it as the obvious solution.

Similarly, when the solution to cybersecurity authentication emerges, everyone will say, “Of course, this is how it had to be.”

The future of identity: A credential will be provisioned to a user's mobile device in a very simple process; the user will then click one button on his/her mobile device to sign on to both web based and mobile applications. All processes will be cryptographically secure.

A recent article, The Future Of Web Authentication, stated, “So far, no one has found an intuitive, affordable way for users to sign in to accounts with the same kind of uniform acceptance as passwords.” That statement is now false. Our technology exceeds all expectations, especially in security and ease of use.

Our technology will enable secure authentication to all types of information systems. We have a change the world technology that is simple, effective, low cost, easy to implement and cryptographically secure.

The basic question is, how can trust be established in the digital age? If you and I have never met and I come to your website or place of business, how can you be confident that I am who I say that I am? The Trust Nexus answers this basic question regarding the establishment of trust. As a very specific example, our technology will completely eliminate the recent thefts of intellectual property and intelligence information by the Chinese army: P.L.A. Unit 61398.

Imagine going to your local bank or corporate security desk and having a digital credential provisioned to your smart phone.

Once this or any other credential is provisioned in a valid institutional process, from then on, whenever you sign onto the institution's website (or mobile application) you simply scroll to the credential's icon on your smart phone and engage the “One Click Sign On”™ process.

The essence of our process is incredibly simple: Through secure mobile identity, we completely do away with user names and passwords (and all of their weaknesses). If a credential is provisioned to a user's mobile device in a valid institutional process, then when the user presents the credential (either in person or over the network) the receiver can be certain that either the credential and the user are valid or the user gave his/her mobile device and six digit HEX pin (1/16,777,216) to someone else.

Under the Trust Nexus it truly does not matter who you are; what matters are institutional validations and the ability to verify those validations.

Most authentication schemes depend on securing private data; we focus on the ability to use data in a valid institutional process. The concept of verifying institutional validations rather than securing secret data requires a shift in perspective. Once that mental shift occurs everyone is amazed at how simple our system is.

In the most basic use case, the credential provider of a web application simply wants to secure the account to the individual who created the account. Identity does not need to be established; valid authentication (to the user who created the account) simply needs to be secure and repeatable. Under the Trust Nexus this criteria is securely met in a process that provisions a user's credential over the Internet. In this process a user can secure access to an account without revealing anything about his/her identity. Pseudo identities become a viable option.

The process for “Creating an Identity Credential” can also be applied in a secure setting (e.g., the issuance of corporate identity credentials at a security station or the issuance of financial credentials at a bank). This secure provisioning represents a high level institutional validation. Under the Trust Nexus the user's identity is verified in a valid institutional process.

Our infrastructure technology can exist as a microcosm within corporations or government agencies when there is no need for third party validation of credentials (i.e., the corporation or government agency simply wants to authenticate its own members). When third parties must rely on credentials (e.g., drivers licenses, passports, financial credentials, insurance credentials, etc.) there will be a public identity infrastructure that will be run in cooperation with governments worldwide.

In essence, there are a limited number of institutions worldwide (measured in thousands) that truly matter when it comes to legitimizing identity. Digital wallets on mobile devices will enable the efficient association of unique public/private keys to a specific individual's legal identity (legal name and legal address). If there is a non-unique association, an inconsistency arises in the system. If the association is unique and verified by multiple legitimate institutions, an individual's identity is secure (as long as the private key on his/her mobile device is secure).

Our ultimate goal is the creation of a worldwide identity infrastructure that will be managed by governments in a fashion similar to the management of the electric power grid.

While many of our cryptographic processes are similar to the processes used in Public Key Infrastructure (PKI), we avoid the bureaucratic inconveniences and lax security inherent in PKI.

Under PKI, when a digital certificate is issued the user (or a malicious administrator or someone who can access the user's system) can simply “share” the cert with anyone. Under the Trust Nexus it is far less likely that a user will share his/her mobile device and six digit HEX pin.

If a practical worldwide system is to be created, it must go beyond the traditional PKI process of having a Certificate Authority issue and manage public/private keys for users; such a system is simply unworkable on a multi-billion user scale.

Removing the need for a Trust Authority to verify billions of individual identities and manage billions of public/private keys makes a world wide system practical.

Also, under the Trust Nexus a catastrophic security breach of the PKI, similar to the Comodo Security Breach, would have no ill effects for users. Contrary to the proponents of PKI, a Comodo-like security breach is always a possibility, especially if you travel to a hostile foreign country or if you are a citizen under an oppressive regime.

One of the most important aspects of our technology is that we secure identity while protecting privacy. Our technology provides a 100% privacy protection. We do not store personal data, we store dual signed SHA-512 message digests of digital credentials. We change the mind set of authenticating using personal data; instead, we verify institutional validations.

If you are a member of the Secret Moose Lodge of Ottumwa, Iowa, your identity credential can be validated under the Trust Nexus without any detailed information about you or your organization being revealed. We simply verify the institutional validation that was created when your credential was issued.

Under the Trust Nexus it is possible for users to create pseudo-identities and conduct financial transactions in complete anonymity. Users are always in complete control. They can create accounts with their “legal identity” or choose from one or more pseudo-identities that they have created for various purposes.

Under the Trust Nexus once a financial institution has provisioned a credential to a user's mobile device in a valid institutional process the user can conduct secure financial transactions without revealing any information about the details of the financial credential. In a soon to be standard Internet transaction, through secure asynchronous cryptographic processes the user's mobile device will receive the transaction details from the provider's website. These details along with a transaction UUID signed with the user's private key will be sent to the user's financial institution. The financial institution will return the transaction UUID signed with it's private key to the user's mobile device. This dual signed transaction UUID will then be sent to the Internet provider which will send the values to the financial institution as secure tokens for payment processing.

Our technology goes beyond secure mobile identity. It may be difficult to believe, but as a small startup in Austin we have solved the single sign on problem.

Our technology also enables a greatly simplified identity federation process.

The major limitation of this system is that there is a loss of functionality if your smart phone loses connection. However, even if there is a loss of mobile service, most home environments, most corporate environments and most retail areas have or soon will have a WiFi service that will make the credential management app operational. If both mobile service and WiFi service are down, it probably means there is a complete power failure and any services you wish to access are also down.

This is not theoretical; we have a functioning prototype and everything works.

The Trust Nexus system is simple, effective, low cost, easy to implement and cryptographically secure.

We are creating an infrastructure that will support the rapid growth of mobile-Identity and mobile-Commerce. In order to establish our infrastructure and generate good will, much of our technology will be licensed for a nominal fee or given away for free. Our technology and infrastructure services will be free for every publicly facing website for general user authentication. There will be licensing fees for corporations and government agencies for internal authentication.

The Trust Nexus will not attempt to compete against the dozens of existing players in the identity management space. We intend to license our authentication technology to all players for a nominal fee; this will insure a rapid and widespread implementation.

The Trust Nexus will also provide the business model for the success of NFC. Once NFC can be used to eliminate fraudulent financial transactions there is a true “value add” for the technology (it becomes much more than just a new “high tech” way of doing the same old thing).

### BRIEF DESCRIPTION OF THE SEVERAL VIEWS OF THE DRAWING

“Not Applicable”

### DETAILED DESCRIPTION OF THE INVENTION

### Introduction

The TNX Cryptographic Protocols enable the creation of a system for secure mobile identity.

If a credential is provisioned to a user's mobile device in a valid institutional process, then when the user presents the credential (either in person or over the network) the receiver can be certain that either the credential and the user are valid or the user gave his/her mobile device and six digit HEX pin (1/16,777,216) to someone else.

Basic assumption: the user installs the TNX Secure mobile app in a secure process. This insures that the institutional provider's public key is provisioned securely.

When the TNX Secure mobile app is initialized the user's public/private key pair is created. The public key is uploaded and associated with the user in the institution's data structure. The user's private key is stored securely on his/her mobile device and never exposed.

In the initialization process of the TNX Secure mobile app the user creates a PIN value. There is an option between an enhanced six or eight digit HEX PIN screen (values 0 to F). The PIN value is not used to encrypt data, it is used to create an obfuscated user identifier that is only available to the user.

In the initialization process of the TNX Secure mobile app a 256 bit AES “primaryUserKey” is created. This key is used to encrypt data on the mobile device (including the user's private key). Once the key is created it is off loaded to a server in the TNX Secure Infrastructure and associated with the user's obfuscated identifier. When a user starts the TNX Secure mobile app the “primaryUserKey” is downloaded.

In one of the most basic scenarios a credential is provisioned to a user's mobile device at the corporate security office. An authentication code is provided to the user. The user enters this code into his/her mobile device. The credential is provisioned. The user and the administrator at the corporate security office both see a verification code on their screens.

In the provisioning process the user's data, most importantly the user's public key, is associated with the user's credential. The provisioning process represents an institutional validation of the user. In the future, it is a very simple cryptographic process to verify this institutional validation.

In the future, when the user presents the credential (either in person or over the network) the receiver can be certain that either the credential and the user are valid or the user gave his/her mobile device and six digit HEX pin (1/16,777,216) to someone else.

### Overview

The TNX Cryptographic Protocols enable the creation of secure digital credentials on mobile devices.

As additional benefits, the TNX Cryptographic Protocols realize the “Holy Grail” of single sign on [ref] and enable an incredibly simplified federation process.

The TNX Cryptographic Protocols enable secure storage of data on a user's mobile device AND prevent access to this data if the user's mobile device is lost or stolen [seriously, we have solved this problem without needing access to the secure element of the mobile device]. If Alice's mobile device is stolen by Ted, Ted is unable to even view Alice's personal data, much less use that data to authenticate to a system or make a fraudulent financial transaction.

We expect the TNX Cryptographic Protocols to become the world wide standard for securing mobile data.

The TNX Secure Infrastructure is a J2EE web application that, along with the TNX Secure mobile app, provides a complete implementation of the TNX Cryptographic Protocols. This is not theoretical; we have a functioning prototype and everything works.

The TNX Secure mobile app is a digital wallet for managing both identity and financial credentials. Additionally, this digital wallet enables users to manage their advertising/marketing preferences and their personal profile (the information about the user that is sent to third parties).

The source code for both the TNX Secure Infrastructure and the TNX Secure mobile app is available. There is an essential reason why we are making the source code public: A system is truly secure if the plans for the system are public, and the bad actors can still not break in.

Note: All technologies described here in are “Patent Pending”. While each individual aspect of the system is not unique, the unique combination of all the aspects creates a system that enables the creation of secure digital credentials on mobile devices, prevents identity theft, prevents fraudulent financial transactions, protects privacy, enables a simplified federation process and provides a consumer friendly “One Click Sign On”™ process.

We are very confident our patent applications will pass the Graham Factors for non-obviousness, especially the factors that show, “objective evidence of non-obviousness”:
commercial success
long-felt but unsolved needs
failure of others

Basically, if we create a system that works, patents will be awarded.

The utility of the Trust Nexus will not lead to duplication even after the patents expire. Once the infrastructure is created and widely adopted it will be nearly impossible to displace the infrastructure. A good analogy is the electrical power grid. There are many players that compete in the production of electricity, but no one attempts to replace the basic infrastructure.

While these protocols are described at a conceptual level, the implementation provides pragmatic, easy to follow source code for the software engineer.

There are four primary actors within the TNX Cryptographic Protocols:
user
credential provider
infrastructure provider
third party accepting a credential

There are two types of credentials: “two party” and “three party”. A “two party” credential functions between the user and the credential provider (e.g., a credential for signing onto a corporate web application). A “three party” credential is issued to a user by a credential provider and is presented to a third party (e.g., a credit card or driver's license).

In most cases the infrastructure provider will be the Trust Nexus. In some cases the infrastructure provider and the credential provider will be the same actor (e.g., a large corporation or government agency that completely runs its own system).

While the Trust Nexus will provide infrastructure services, the license does not prohibit organizations from running their own infrastructure. In fact, the availability of the source code and data structures makes this very easy to do. The license does prevent an organization from providing third party services.

### Communication Between the Mobile App and the Servers

Note: It is good coding practice to use descriptive variable names. In the exposition that follows the actual variable names that are used in the source code are presented within quotes and highlighted in Indigo (e.g., “variableName”).

Primary Assumption: The TNX Secure mobile app is provisioned to a user's mobile device in a secure process. This insures the initial integrity of the TNX Secure (infrastructure provider) public key. We assume that downloading the TNX Secure mobile app from the Google PlayStore or Apple Store is a secure process.

Even if a bad actor can trick a user into installing malware that has the “look and feel” of the TNX Secure mobile app or even if a bad actor can replace an existing TNX Secure mobile app with malware, the system CANNOT be compromised. False authentications cannot be made. Fraudulent financial transactions cannot be made. The worst case scenario is that valid authentications and transactions will not be made.

Communication between the mobile app and the servers (both the servers of the infrastructure provider and the servers of the credential provider) follows a basic design pattern.

There are three packages sent in every secure transmission from the mobile app to the server:
“packageOne”: A one time “transferKey” encrypted with the public key of the provider.
“packageTwo”: The data being sent; this data is encrypted with the one time “transferKey”.
“packageThree”: A “Message Authentication Code” that insures the integrity of the message.

This structure insures the communication between the mobile app and the server is secure and uncompromised. If a bad actor intercepts the message he/she cannot access the encrypted data. If a bad actor attempts to change the message, that change will be detected.

The symmetric “transferKey” is used for efficiency. Encrypting the data package with the provider's asymmetric public key is inefficient.

Note: Our primary concern at the beginning of this project was the speed of cryptographic processes on Android based mobile devices. We were pleasantly surprised. Even with 4,096 bit asymmetric keys and 256 bit AES symmetric keys the process times on an Samsung Nexus S are sub-second (with the exception of the creation of the public/private key pair itself, which takes about thirty seconds).

The reference implementation of the TNX Cryptographic Protocols uses incredibly strong keys: 4,096 bit asymmetric keys and 256 bit AES symmetric keys According to RSA, “2048-bit keys are sufficient until 2030. An RSA key length of 3072 bits should be used if security is required beyond 2030.” Also, “The U.S. Government requires 192 or 256-bit AES keys for highly sensitive data.”

### Securing User Data on the Mobile Device

When a user first activates the TNX Secure mobile app the user's basic profile information (at a minimum: screen name and contact email address; at a maximum: screen name, contact email address, legal name and legal address) along with a “Universally Unique Identifier” are sent to a server in the TNX Secure Infrastructure (or to a server run by the infrastructure provider).

“Universally Unique Identifiers” are truly magical. The chances of two independently generated UUIDs being duplicates is incredibly small: “To put these numbers into perspective, one's annual risk of being hit by a meteorite is estimated to be one chance in 17 billion, that means the probability is about 0.00000000006 (6×EE-11), equivalent to the odds of creating a few tens of trillions of UUIDs in a year and having one duplicate. In other words, only after generating 1 billion UUIDs every second for the next 100 years, the probability of creating just one duplicate would be about 50%. The probability of one duplicate would be about 50% if every person on earth owns 600 million UUIDs.”

Once the user's basic profile information is sent, another asynchronous process (transparent to the user) is launched to create the user's public/private key pair. The process to create a 4,096 bit public/private key pair takes about thirty seconds on a Samsung Nexus S. Once the keys are created, the public key is sent to a server in the TNX Secure Infrastructure and the private key is stored temporarily within memory in the TNX Secure mobile app.

Note: The TNX Cryptographic Protocols insure that a user's private key is never exposed, not even to the infrastructure provider. This self-creation and self-management of the public/private key pairs makes a worldwide system with billions of users possible.

How can data be secured on a mobile device even if the mobile device is lost or stolen? PIN based phone locks (used by all smart phone manufacturers) and PIN based application locks (used by Google Wallet, ISIS Wallet and others) are notoriously insecure.

“Your PIN affords you little protection if someone gets hold of your iPhone.” [MacWorld]

The reason PIN based passwords are so easy to crack is that there are a limited number of possibilities to consider: 10,000 for a four digit PIN. Text based passwords offer greater security if the passwords are long and complex, which, unfortunately, is an inconvenience for users. Given that there are about ninety-four symbols available on a standard keyboard, a complex eight symbol password has 6.1×EE 15 possibilities (6.1 billion times 1 million). While this seems like a large number, even text based passwords are open to Brute Force Attacks.

The only way to secure data on a mobile device is to encrypt the data with a key that is stored off the device, destroy the key when it is not needed and load the key in a secure process when it is needed.

In the initialization process of the TNX Secure mobile app a 256 bit AES “primaryUserKey” is created. This key is used to encrypt data on the mobile device (including the user's private key). Once the key is created it is off loaded to a server in the TNX Secure Infrastructure and associated with the user's obfuscated identitfier. When a user starts the TNX Secure mobile app the “primaryUserKey” is downloaded.

The process of loading the “primaryUserKey” is a sub-second process, unnoticeable to the user.

The downside of this process is that there is a loss of functionality if the user's mobile device loses connection. However, even if there is a loss of mobile service, most home environments, most corporate environments and most retail areas have or soon will have a WiFi service that will make the TNX Secure mobile app operational. If both mobile service and WiFi service are down, it probably means there is a complete power failure and any services the user wishes to access are also down.

### Securing the Primary User Key

One of our goals in this project was to create a completely transparent system where everyone could examine the system for flaws. In one of the early reviews we were forced to consider the possibility of bad actors within the TNX Secure Infrastructure (or within the infrastructure provider in the case of a large corporation or government agency).

In an early version of the system, if a bad actor had unrestricted access to the TNX Secure Infrastructure he/she could associate a user's UUID to the user's “primaryUserKey”. If the bad actor could then steal the user's mobile device havoc would reign.

We solved this problem in a unique way by creating an obfuscated identifier that is only available to the user and then completely disassociating this identifier from all other aspects of the TNX Secure Infrastructure.

When a user initializes the TNX Secure mobile app the user creates a PIN value. There is an option between an enhanced six or eight digit HEX PIN screen (values 0 to F). The PIN value is not used to encrypt data, it is used to create an obfuscated user identifier that is only available to the user.

The goal is to obfuscate the PIN values so that they are unique within the TNX Secure Infrastructure and not traceable back to any specific user. This is done by creating a “PBEKeySpec” using three items: the bytes of the PIN string, a SALT value and an iteration count. The SALT value is a Universally Unique Identifier that is combined with the bytes of the PIN string and is used for obfuscation. If SALTs were not used, everyone with the same PIN and using the same iteration count would have the same identifying value.

We use the value from the PBEKeySpec to create a 256 bit AES symmetric key, This key is used to initialize a Message Authentication Code object; this object is then used to create a hashed value of the user's UUID. This hashed value becomes the user's identifier associated with his/her “primaryUserKey” within the TNX Secure Infrastructure.

When a user activates his/her TNX Secure mobile app the process is repeated and a secure request is made to the TNX Secure Infrastructure which returns the user's “primaryUserKey” which the user can then use to encrypt and decrypt data on his/her mobile device.

If a bad actor steals the user's mobile device and attempts to randomly guess the user's PIN, with each guess the TNX Secure mobile app must check with a server in the TNX Secure Infrastructure; there is a time out feature that inactivates the TNX Secure mobile app after a certain (configurable) number of failed attempts.

This process prevents a brute force attack.

There is a very low probability that a bad actor could correctly guess a user's PIN:
Standard Four Digit Numeric PIN Screen (values 0 to 9): 1/10,000
Enhanced Six Digit HEX PIN Screen (values 0 to F): 1/16,777,216
Enhanced Eight Digit HEX PIN Screen (values 0 to F): 1/4,294,967,296

Note: We even have an answer for the “Jack Bauer” scenario where evil actors kidnap and torture you to get your HEX pin. There will be an alternate HEX pin that will be a “duress code”; it will appear to sign you in and the authorities will be notified of your GPS location.

### Creating an Identity Credential

For highly secure credentials, government agencies, corporations and financial institutions will provision credentials in a secure internal process: users will bring their mobile device to the security office or branch location.

Credentials can also be provisioned through an Internet process: users will go to a web page run by the credential provider. In this process there is a general assumption that communication between the Internet browser and server takes place over a secure SSL/TLS connection.

In the most basic use case requiring a low level of authentication, a user goes to web application to create a new account. The provider of the web application does not really care who the user is, the provider just wants to make sure the user's account is secure and can only be accessed by the user who created the account.

It is a very simple process for a user to create a new identity credential and sign on to a web application for the first time.

Note: The creation of the identity credential is a one time process.

When a user goes to a new web application he/she will see the following notification:
TNX Secure˜Create Credential
Enter the authentication code “TNX LMPW” (include space) in your TNX Secure mobile app.
00:02:56 until this page expires.

The user enters the “providerCode” and “authenticationCode” (“TNX LMPW”) into his/her TNX Secure mobile app and clicks “Authenticate”.

Once the user clicks “Authenticate” a secure transmission is sent to a server in the TNX Secure Infrastructure requesting the provider data. The “transferKey” that was used to encrypt the data package in this request is held in the TNX Secure mobile app. The server returns the provider data encrypted with the original “transferKey”; the server also returns a “Message Authentication Code” that insures the integrity of the message.

This process insures the communication between the server and the TNX Secure mobile app is secure and uncompromised. If a bad actor intercepts the message he/she cannot access the encrypted data. If a bad actor attempts to change the message, that change will be detected. This process insures the provider's public key is securely downloaded to the TNX Secure mobile app.

Once the provider data is securely downloaded, the user is taken to a “profile” page where he/she can select how much personal information to send to the credential provider.

Prior to sending the user data to the credential provider, the TNX Secure mobile app makes a request to the TNX Secure Infrastructure for a “transactionUuid”. The TNX Secure Infrastructure records the request, associating the “userUuid” with the “transactionUuid” then sends the “transactionUuid” to the TNX Secure mobile app.

Along with the user's personal data the TNX Secure mobile app sends the credential provider the “transactionUuid” signed with the user's private key. Once the data is received, the credential provider requests the user's recently recorded “transactionUuid” and public key from the TNX Secure Infrastructure. The credential provider can then check the signature of the “transactionUuid”. If the “transactionUuid” is valid and the signature is valid the credential provider can be certain that a user associated with the given “userUuid” has sent the personal data.

This process of creating, signing and verifying a “transactionUuid” is used in most processes between the TNX Secure mobile app and servers in the TNX Secure Infrastructure or servers run by a credential provider. This process replaces the need for the “RSA SecurID key fob” or other similar devices.

Once the user data is securely uploaded and the user's account is created by the credentialProvider the user is notified, “Credential successfully created”. A “verificationCode” (“QSY 429”) is displayed on TNX Secure mobile app.

The user's web page is “auto-magically” transformed with a, “Thank you”, message and the “verificationCode” (“QSY 429”) is displayed.

When the user clicks “Authenticate” the “Standard Sign On” process is engaged.

A verificationCode (“TXY 302”) is displayed on the mobile app and on the web page.

It is very important to note that this process for “Creating an Identity Credential” can also be applied in a secure setting (e.g., the issuance of corporate identity credentials at a security station or the issuance of financial credentials at a bank). This secure provisioning represents a high level institutional validation.

The NFC capabilities of mobile devices will enable a seamless process with no need for “providerCodes” or “authenticationCodes”.

### Standard Authentication

Behind the scenes, when a user first goes to the Standard Authentication page an asynchronous process is launched that reads the “userUuid” from the cookie value and then creates a data base record containing that “userUuid” and a newly created “sessionUUID” (a check is made to insure there are not duplicate sessions from the same user; this insures that a “bad actor” cannot hijack a valid user's session simply by manipulating the cookies on another computer).

The asynchronous process then polls the data base record every five seconds (configurable) and “asks” the question, “Has this user been authenticated?” If the answer is yes, the “verificationCode” and welcome message are displayed.

When a user enters the “authenticationCode” in the TNX Secure mobile app and clicks “Authenticate”, the following information is sent to a server in the credentialProvider's infrastructure:
“authenticationCode”
“userUuid”
“userPasscode”
“transactionUuid”
“transactionUuidSigned”
“verificationCode”

The “userPasscode” was created during the sing up process; it enables a simplified authentication. If a credentialProvider wants an alternative to the process of verifying the user's “transactionUuidSigned”, verifying the “userPasscode” is sufficient in many cases.

Note: The “userPasscode” is an SHA-512 message digest of the value stored on the user's TNX Secure mobile app.

In a full authentication process the user's “transactionUuidSigned” is verified using the user's public key. The only way the “transactionUuidSigned” can be verified is if it was created with the user's private key. This process insures that when the user presents the credential (either in person or over the network) the receiver can be certain that either the credential and the user are valid or the user gave his/her mobile device and six digit HEX pin (1/16,777,216) to someone else.

### New Computer First Time Sign On

This is a one time process.

When a user signs on from a new computer for the first time he/she will see the “TNX Secure Sign On˜Initialize” page.
TNX Secure Sign On˜Initialize
The first time you sign on to a new system you must enter the contact email address for your TNX Secure account.
   [INPUT TEXT BOX] [SUBMIT BUTTON]
If you do not have an account, “Click Here” to create an account.

The user simply enters his/her email address and is transferred to the “TNX Secure Sign On˜One Click” page.

The authentication process takes place between the TNX Secure mobile app, and the servers within the TNX Secure Infrastructure not within the browser. There is no danger that a “bad actor” could enter a user's contact email address and sign on from a random web page.

Originally, for “New Computer First Time Sign On”, we simply had a user go to an authentication page and enter an authentication code from the page into his/her TNX Secure mobile app.

This authentication code was randomly generated and guaranteed to be unique over a configurable time period; however, there was a slight possibility that User A could mis-enter an authentication code that was meant for User B resulting in User B being “auto-magically” signed onto User A's account.

By entering his/her contact email address the user's secure HTTPS session is associated with his/her account and the cryptographic processes for One Click Authentication can then securely authenticate the user.

### One Click Authentication

Under the TNX Secure system it is possible for the user to click one button on his/her TNX Secure mobile app and securely sign on to a web or mobile application.

When a user signs on to a new computer for the first time the user's “userUuid” along with the user's “screenName” and “contactEmail” address are stored as cookie values in the Internet browser. When a user returns to the web application he/she sees the following message:
TNX Secure˜One Click Sign On
“One Click Sign On”™ is authorized for Michael with contact email address mduffy@austin.rr.com.
Simply scroll to The Trust Nexus on your TNX Secure mobile app and click.
If you are not Michael, please click Here to initialize your system. 00:01:54 until this page expires.

The user simply scrolls to the appropriate credential and clicks.

The user is notified, “Sign On Successful”, and a, “Verification Code: LWR 533”, is also displayed for the user.

Behind the scenes, when a user first goes to the One Click Authentication page an asynchronous process is launched that reads the “userUuid” from the cookie value and then creates a data base record containing that “userUuid” and a newly created “sessionUUID”. A check is made to insure there is not a duplicate sessions from another webpage using the same “userUuid”; this insures that a “bad actor” cannot hijack a valid user's session simply by manipulating the cookies on another computer.

The asynchronous process then polls the data base record every five seconds (configurable) and “asks” the question, “Has this user been authenticated?” If the answer is yes, the “verificationCode” and welcome message are displayed.

When a user clicks the appropriate identity credential in the TNX Secure mobile app, the following information is sent to a server in the credentialProvider's infrastructure:
“userUuid”
“userPasscode”
“transactionUuid”
“transactionUuidSigned”
“verificationCode”

The “userPasscode” was created during the sing up process; it enables a simplified authentication. If a credentialProvider wants an alternative to the process of verifying the user's “transactionUuidSigned”, verifying the “userPasscode” is sufficient in many cases.

Note: The “userPasscode” is an SHA-512 message digest of the value stored on the user's TNX Secure mobile app.

In a full authentication process the user's “transactionUuidSigned” is verified using the user's public key. The only way the “transactionUuidSigned” can be verified is if it was created with the user's private key. This process insures that when the user presents the credential (either in person or over the network) the receiver can be certain that either the credential and the user are valid or the user gave his/her mobile device and six digit HEX pin (1/16,777,216) to someone else.

It may seem that the Standard Authentication process which requires a user to enter a code into his/her mobile device is much more secure than the One Click Authentication process. Mathematically, this is not the case; however, from a marketing standpoint the appearance of entering a code seems more secure.

In the Standard Authentication process, the asynchronous process from the user's web page does a discovery against a combination of three factors:
“userUuid”
“sessionUuid”
“authenticationCode”

In the One Click Authentication process, the asynchronous process from the user's web page does not include an “authenticationCode” in the discovery.

In most cases the “authenticationCode” will be a four character string (e.g., “HQWK”) which has 331,776 possible combinations (all upper case eliminate “I” and “O”). An eight character string (e.g., “HQWK GPIM”; which is probably the limit for user convenience) has 110,075,314,176 possible combinations; however, in comparison to a UUID, 110 billion is trivial.

A UUID is represented by 32 hexadecimal digits (e.g., 550e8400-e29b-41d4-a716-446655440000). The number of possible UUIDS is 340,282,366,920,938,463,463,374,607,431,768,211,456 (16̂32). The discovery process is already protected by a UUID so adding a four or eight character string does not really enhance security. Also, the discovery process communication takes place over a secure SSL/TLS connection which means the values cannot be intercepted by a “man in the middle attack”. In the final analysis, the security of the authentication process comes from the “transactionUuidSigned” which depends on the user's private key not on any of the codes used in the discovery process.

An “authenticationCode” will be useful as a one time code in provisioning a digital credential to the TNX Secure mobile app. If this code can be securely communicated to the user an existing account can be associated with the user.

### Downloading a Financial Credential

The key difference between creating an identity credential and downloading a financial credential is that in creating an identity credential most information is uploaded to the credentialProvider while in downloading a financial credential most information is downloaded from the credentialProvider.

Another key difference between an identity credential and a financial credential is that an identity credential is usually a “two party” credential while a financial credential is usually a “three party” credential.

Similar to creating an identity credential the first step in downloading a financial credential is to enter the “providerCode” and “authenticationCode”.

Prior to sending the request data to the credential provider, the TNX Secure mobile app makes a request to the TNX Secure Infrastructure for a “transactionUuid”. The TNX Secure Infrastructure records the request, associating the “userUuid” with the “transactionUuid” then sends the “transactionUuid” to the TNX Secure mobile app.

Along with the request data the TNX Secure mobile app sends the credential provider the “transactionUuid” signed with the user's private key. Once the data is received, the credential provider requests the user's recently recorded “transactionUuid” and public key from the TNX Secure Infrastructure. The credential provider can then check the signature of the “transactionUuid”. If the “transactionUuid” is valid and the signature is valid the credential provider can be certain that a user associated with the given “userUuid” has sent the request data

The credential provider will have a process that insures the request to down load the financial credential is valid. This process will include both a secure method for sending the user the “authenticationCode” and a check against the information uploaded by the user.

As with “Creating an Identity Credentials”, it is very important to note that this process for “Creating a Financial Credential” can also be applied in a secure setting (e.g., the issuance of corporate identity credentials at a security station or the issuance of financial credentials at a bank). The NFC capabilities of mobile devices will enable a seamless process with no need for “providerCodes” or “authenticationCodes”.

Under the Trust Nexus once a financial institution has provisioned a credential to a user's mobile device in a valid institutional process the user can conduct secure financial transactions without revealing any information about the details of the financial credential. In a soon to be standard Internet transaction, through secure asynchronous cryptographic processes the user's mobile device will receive the transaction details from the provider's website. These details along with a transaction UUID signed with the user's private key will be sent to the user's financial institution.

The financial institution will return the transaction UUID signed with it's private key to the user's mobile device. This dual signed transaction UUID will then be sent to the Internet provider which will send the values to the financial institution as secure tokens for payment processing.

### Authenticating a Three Party Credential

How is it possible for a third party to trust a credential issued by a credential provider to a user?

When a financial credential or other three party credential is created, it is treated as an unalterable uniform block of data within the TNX Secure system. This block of data consists of “name/value” pairs describing the attributes of the financial credential. When the financial credential is downloaded to the TNX Secure mobile app it is encrypted as a uniform block with the user's “primaryUserKey” and stored securely. When the financial credential is needed it is decrypted and transmitted as a uniform block of data.

Prior to downloading the credential to the user, the credential provider creates an SHA-512 message digest of the data block. This digest is signed with the credential provider's private key; that signature, along with other credential data is stored within the TNX Secure Infrastructure.

When the TNX Secure mobile app first receives a financial credential it creates an SHA-512 message digest of the data block. This digest is signed with the user's private key; that signature, along with other credential data is stored within the TNX Secure Infrastructure.

This dual signature of the credential data enables a third party to trust the process under which the credential was created.

When a third party receives the financial credential the message digest can be recalculated and the signatures of the credential provider and the user can be validated. With validation of the signatures the third party can be confident that the credential was created in a trusted process.

When a third party receives the financial credential the third party also receives a “transactionUuid” signed with the user's private key. If this signature can also be validated with the public key associated with the “userUuid” the third party can be confident that the user presenting the credential is the same user who created the credential.

Within each financial credential there is an attribute for “trustLevel”. The exact specifications for these levels will be determined at a later date. “Level 0” might be a web based provisioning process; “Level 1” might be some type of out of band provisioning process; “Level 2” might be an in person provisioning process; etc.

When a three party credential is provisioned to a user, especially when the provisioning process involves a very high “trustLevel” (e.g, provisioned in person by the user's personal banker of twenty years), that credential represents an Institutional Validation of the user's identity. A collection of these validations represents an Institutional Web of Trust which establishes and secures a user's identity.

The TNX Cryptographic Protocols enable the creation of a worldwide distributed identity system that secures digital credentials on mobile devices, prevents identity theft, prevents fraudulent financial transactions, protects privacy and enables single sign on. The Trust Nexus will soon be a reality.

The source code for the TNX Secure Infrastructure along with the source code for TNX Secure mobile app, provides a complete implementation of the TNX Cryptographic Protocols and all processes described. This is not not theoretical; everything works.

The source code for both the TNX Secure Infrastructure and the TNX Secure mobile app is available. There is an essential reason why we are making the source code public: A system is truly secure if the plans for the system are public, and the bad actors can still not break in.

The TNX Cryptographic Protocols will eventually include an Ultra process for storing the user's “primaryUserKey” “somewhere” in a distributed network, perhaps even on another user's mobile device.

How is it done today, and what are the limits of current practice?

Currently, usernames and passwords are the most prevalent form of authentication.

A recent article, The Future Of Web Authentication, stated, “So far, no one has found an intuitive, affordable way for users to sign in to accounts with the same kind of uniform acceptance as passwords.” This article provides an overview of the current state of the art.

Highlights from the Article:

The user name-password approach is the lowest common denominator for authentication.

Passwords are particularly problematic for Internet security as frequent hacks and breaches show. Just last month, a breach at LivingSocial, an online coupon company, exposed 50 million user passwords. Such break-ins give hackers the power to masquerade as any number of Internet users online. And when they aren't stealing credentials, cyber thieves use password guessing and cracking tools to compromise authentication systems.

Users themselves frequently assist the thieves, falling for phishing scams and reusing passwords across different sites.

Security leaders for years have said that passwords must be abolished, but the alternatives have fallen flat because they're built on flawed assumptions . . . . For example, challenge-and-response systems assume that attackers can't find the answers to users' established questions. And hardware token systems assume that attackers couldn't steal the tokens or the algorithmic information that powers them.

Hardware tokens and biometrics have worked reasonably well in business environments that require people to sign on to an internal network, hardware device or software system. However, they haven't translated well online, because the cost of providing tens of thousands of people with the hardware is prohibitive.

Two-factor systems based on tokens are difficult to use since people must have the PIN-generating device any time they log on. For online authentication to be widely used, people would have to carry numerous fobs to authenticate into multiple websites. It's an unwieldy process and still based on shared secrets—though admittedly more complicated ones.

### [End Article Highlights]

In addition to the limitations described in the article there are limitations to the other major approaches being proposed for secure authentication: OpenID, OAuth, geo-fencing, and biometrics

How does the Trust Nexus Compare with OpenID?

There is a great deal of controversy surrounding OpenID brought on primarily by those who have over hyped the potential of OpenID.

Stefan Brands (an information technologist specializing in digital identity, security, and privacy) so clearly stated, “OpenID was designed as a lightweight solution for ‘trivial’ use cases in identity management: its primary goal is to enable Internet surfers to replace self-generated usernames and passwords by a single login credential, without needing more than their browser. Concretely, OpenID aims to enable individuals to post blog comments and log into social networking sites without having to remember multiple passwords. Beyond this, OpenID is pretty much useless. The reasons for this are many: OpenID is highly vulnerable to phishing and other attacks, creates insurmountable privacy problems, is not a trust system, suffers from usability problems, and makes it unappealing to become an OpenID ‘consumer.’”

The original OpenID authentication protocol was developed in May 2005. While there are many organizations that offer OpenID, very few users have actually created OpenID accounts. The fact is that most users do not understand the concept of pasting a URL into a sign on field instead of using a user name and pass word.

The primary problem with OpenID from an identity management perspective is that there is no coherent security model for OpenID; because of this, OpenID is relegated to a Level 1 Assurance system (“Little or no confidence in the asserted identity's validity.”) by the federal government.[ref] In contrast, the Trust Nexus uses “hard” cryptographic tokens within a coherent security model and is a Level 4 Assurance system (the highest level; “Very high confidence in the asserted identity's validity.”).

How does the Trust Nexus Compare with OAuth?

No doubt there are many good technical people who have committed long hours to the development of OAuth, unfortunately they have all wasted their time.

While the original OAuth spec had the potential to develop into a sound security model, OAuth 2.0 dumped all cryptographic processes in favor of becoming an “institutional blueprint” for selling services.

These changes caused one of the lead OAuth contributors to resign from the working group: In July 2012, Eran Hammer resigned his role of lead author for the OAuth 2.0 project, withdrew from the IETF working group, and removed his name from the specification. Hammer pointed to a conflict between the web and enterprise cultures, citing the IETF as a community that is “all about enterprise use cases”, that is “not capable of simple”. What is now offered is a blueprint for an authorisation protocol, he says, and “that is the enterprise way”, providing a “whole new frontier to sell consulting services and integration solutions”.

In comparing OAuth 2.0 with 1.0, Hammer points out that it has become “more complex, less interoperable, less useful, more incomplete, and most importantly, less secure” . . . . He explains how architectural changes for 2.0 unbound tokens from clients, removed all signatures and cryptography at a protocol level and added expiring tokens because tokens couldn't be revoked while complicating the processing of authorisation. Numerous items were left unspecified or unlimited in the specification because “as has been the nature of this working group, no issue is too small to get stuck on or leave open for each implementation to decide”.

The fundamental flaw with OAuth 2.0 is that it is a, “Delegated Authorization protocol, and not an Authentication protocol.” The Trust Nexus focuses exclusively on the authentication piece of the identity management puzzle; we leave the authorization piece of the puzzle to the hundreds of identity management system providers.

How does the Trust Nexus compare with mobile apps that use “geo-fencing”?

While the idea of restricting sign on based on geographic locals may at first seem interesting, if I can compromise your identity by driving over and parking in front of your house, the system is not that secure.

### What are the Advantages of Biometric Factors?

There are severe limitations in using biometric data over a network or in a physical location with no monitoring; one of the most notable failures of biometrics is the “Gummi Bear Hack” used by Australian school children to defeat fingerprint sensors (and verified by Japanese researchers).

Most recently, a group of German hackers cracked the iPhone fingerprint scanner just two days after Apple Inc. launched the technology that it promises will better protect devices from criminals and snoopers seeking access.

A biometric identifier is like a “magic word” that supposedly only the person associated with the identifier can say. But once the “magic word” is spoken anyone who can programatically access the identifying device (or the resulting digital stream) can speak the “magic word” and steal the user's identity.

When the person is present and the biometric data can be verified in the presence of a security agent, the utility of biometric processes increases significantly.

Under the Trust Nexus it will be possible to store biometric data within a user's credential (not within a central repository) when the credential is created by the provisioning institution. When a user presents the credential, verifying the biometric data in the credential against the individual in real time will provide enhanced security.

While there are many types of biometric identifiers, one of the simplest and most usable is a photograph of the human face verified by a human being. In the Trust Nexus any credential in a user's digital wallet that includes a photograph (driver's license, passport, bank debit card, etc.) will be highly reliable when a user presents the credential in person.

Iris scan identification, voice authentication and face recognition algorithms have become increasingly reliable; any one could provide an additional layer of security.

Whatever type of biometric factor is used, the fact that the biometric (and all other) information in the Trust Nexus is stored in a user's digital wallet on his/her mobile device and not stored in a central repository means there cannot be a massive theft of identity information. Systems that attempt to create vast repositories of biometric information will simply be storing extremely long “magic words” that are available for compromise.

How Many “Factors” does the Identity System of the Trust Nexus Contain?

The Trust Nexus is a three factor identity system:
Something the user has” (a digital wallet with a secure private key).
Something the user knows (a PIN number to access the user's digital wallet).
Something the user is or does (photo ID, voice recognition and other forms of biometrics).

Additionally, the TNX Cryptographic Protocols [ref] create an “ultra factor” for authentication: “a relationship verified by a legitimate institution”. In the Trust Nexus authentication process, this “ultra factor” combines all three traditional factors (“know”, “have” and “are”).

The Trust Nexus meets the criteria for strong authentication as defined by the U.S. government's National Information Assurance Glossary: “Layered authentication approach relying on two or more authenticators to establish the identity of an originator or receiver of information.”

The geo-spatial capabilities of mobile devices opens the possibility of location-based authentication being incorporated into the Trust Nexus.

The Trust Nexus also meets all the goals of the Department of Homeland Security's program for Secure Driver's Licenses (formerly the “Real ID Act”) with out any of the problems.

### Is the Technology of the Trust Nexus a “Disruptive Technology”?

Secure digital credentials on mobile devices represent a “Disruptive Technology” that will significantly impact every aspect of identity management.

The term “Disruptive Technology” comes from Clayton Christensen's classic treatise, The Innovator's Dilemma. Christensen points out that the fatal flaw in corporate strategy is to allocate resources based exclusively on improvements in “sustaining technologies” while ignoring innovation in “disruptive technologies”.

“Disruptive technologies typically offer a cheaper solution to a small, often unidentified subgroup. Once established within this small market the disruptive technology evolves through sustaining technology until it eventually satisfies the performance criteria of more traditional markets. When this happens, the disruptive technology bursts onto the scene, attacking the soft underbelly of the established corporations, often with fatalistic consequences. In the parlance of evolutionary biology, disruptive technology is like punctuated evolution; fast with significant changes in the gene pool.”

1. A system for “Secure Mobile Identity” comprising:
(a) the provisioning of a digital credential in a valid institutional process to the user's mobile device
(b) using cryptographic processes that enable the repeated verification of the credential in a local or non-local process
(c) storing data that is representative of the credential provisioning process not necessarily of the individual
(d) not requiring any administrative process for creating and issuing private keys.

2. The method of claim one involving a “One Click Sign On” process where the user can go to web application or mobile application or other application and securely sign on by clicking one button on his/her mobile device.

3. The method of claim one where an identity credential is verified without knowing any data about the individual or the credential except that it was provisioned in a valid process; limited or pseudo information about the individual could also be used; thus protecting the individual's privacy.

4. The method of claim one where all the data on the user's mobile device is encrypted by a personal cryptographic key that resides off the device and is retrieved when the user signs onto the device; an obfuscated identifier is created and sent to a server in a secure transmission process; this identifier is associated with the user's personal cryptographic key; the key is sent to the user's mobile device in a secure transmission process.

5. The method of claim one where the individual uses pseudo-identities to conduct financial transactions in complete anonymity.

6. The method of claim one where a financial credential is verified without knowing any data about the individual or the credential except that it was provisioned in a valid process; thus protecting the individual's privacy.
